(19) United States
(12) Patent Application Publication
(10) Pub. No.: US 2003/0225887 A1
(43) Pub. Date: Dec. 4, 2003

(54) Establishing IP level connectivity by use of L-2 dormant mobile node activation

(76) Inventors: Rene Purnadi, Coppell, TX (US); Stefano Faccin, Dallas, TX (US); Srinivas Sreemanthula, Flower Mound, TX (US)

Correspondence Address: CRAWFORD PLLC, Suite 390, 1270 Northland Drive, St. Paul, MN, 55120, US

(21) Appl. No.: 10/156,652

(22) Filed: May 28, 2002

(51) Int. Cl. G06F 15/16

(52) U.S. Cl. 709/227; 709/218; 709/249

(57) ABSTRACT

A method, system, and device provide for establishing IP level connectivity between an L-2 dormant mobile node (MN) and an IP cellular network, such as a Mobile IPv4, IPv6, of hybrid Mobile IPv4/IPv6 cellular network. An L-2 dormant mobile node detects a condition requiring enablement of IP level connection to execute the IP level procedures. The L-2 dormant mobile node, in response to detecting the condition, sends an initiation signal to the radio access network. The radio access network, in response to the initiation signal, initiates a radio bearer setup to facilitate executing of the IP level procedures. The radio bearer, in one approach, is a default radio bearer associated with the mobile node.

### FIELD OF THE INVENTION

The present invention relates generally to IP and Mobile IP networks, such as IPv4, IPv6, Mobile IPv4, and Mobile IPv6 networks, and, more particularly, to a method, system, and device for establishing IP level connectivity by use of an L-2 dormant mobile node activation process to initiate IP level procedures.

### BACKGROUND OF THE INVENTION

An important objective of cellular mobility standards in GPRS (General Packet Radio Service) and WCDMA (Wideband Code Division Multiple Access) networks has been to provide global connectivity, where the IP (Internet Protocol) layer is not involved in the mobility management. Achieving this objective makes it possible to continue using existing IP enabled access devices when moving in the network, such as portable laptop computers connected to GPRS terminals.

This capability is referred to as link layer or layer-2 mobility. In link layer mobility, access to IP networks is gained through use of a specific IP router, such as a Gateway GPRS Support Node or GGSN.

An important set of layer interactions concerns the relationship between IP packets and flows in the IP layer (layer-3) and radio bearers (RBs) in the link layer (layer-2). A radio bearer is employed to exchange IP packets between a mobile node and the network, typically via an access router (AR). In current cellular systems, such as an UMTS Radio Access Network (UTRAN) which employs Radio Network Controllers (RNCs) and base stations (BS), for example, it is the network that initiates the radio bearer setup. However, the layer-3 (IP) technology of the network is completely unaware of the radio bearer concept. As such, the network has no information as to whether a given mobile node needs to set up a radio bearer to execute IP level procedures. This scenario is further complicated when the mobile node in question is in an L-2 dormant state, in that the mobile is not reachable at the layer-3 (IP) level.

The present invention addresses these and other needs, and provides additional features and advantages over conventional implementations and techniques.

### SUMMARY OF THE INVENTION

The present invention is generally directed to a method, system, and device for establishing a radio bearer between a radio access network and a mobile node while in a layer-2 (L-2) dormant state to enable IP level procedures at an IP core network. According to one embodiment of the present invention, an L-2 dormant mobile node detects a condition requiring enablement of IP level connection to execute the IP level procedures. The L-2 dormant mobile node, in response to detecting the condition, sends an initiation signal to the radio access network. The radio access network, in response to the initiation signal, initiates a radio bearer setup to facilitate executing of the IP level procedures. The radio bearer, in one approach, is a default radio bearer associated with the mobile node.

Detecting the condition by the L-2 dormant mobile node may involve detecting an L-2 broadcast or paging message. In one approach, detecting the condition involves detecting a paging request, while in another approach, detecting the condition involves detecting information indicative of an IP paging area change. According to one particular approach, in an absence of IP paging, detecting the condition involves detecting a radio routing area change, and initiating the radio bearer setup facilitates execution of the IP level procedures.

In a further approach, detecting the condition involves detecting expiration of a timer in the dormant mobile node. The timer can be an L-2 dormant timer in the dormant mobile node. Executing of the IP level procedures can involve refreshing a dormant state of an IP dormant timer of the mobile node.

In another approach, detecting the condition involves detecting in the L-2 dormant mobile node an indication to originate an IP call requiring IP level connectivity with the IP core network. Executing of the IP level procedures can involve obtaining new IP connectivity information of the mobile node and updating the new IP connectivity information to the IP core network.

Executing the IP level procedures may involve activating the dormant mobile node. Also, IP level messages may be communicated between the mobile node and the IP core network. Executing the IP level procedures can also involve obtaining a new IP address for the mobile node or sending a paging update message to the IP core network. In one particular approach, detecting the condition involves detecting a new IP paging area identifier, and executing of the IP level procedures involves updating a paging area location of the mobile node. A binding update can be performed to update the paging area location of the mobile node.

In yet a further approach, detecting the condition involves detecting a new routing area identifier, and executing of the IP level procedures involves obtaining new IP connectivity information of the mobile node and updating the new IP connectivity information to the IP core network. A binding update can be performed to update the new IP connectivity information of the mobile node.

The initiation signal, according to one approach, includes a Routing Area Update Request having an update type indicative of an IP paging area update request. In another approach, the initiation signal includes an RRC Connection Request, wherein a list of Establishment Causes of the RRC Connection Request includes an entry indicative of a need for a radio bearer setup. In a further approach, the initiation signal includes an L-2 QoS Request for setting up the radio bearer.

In accordance with another embodiment, a communication system of the present invention includes a core network access interface for accessing an IP core network and a radio access network interface for accessing a radio access network. The system further includes a mobile node. The mobile node, when in an L-2 dormant state, detects a condition requiring enablement of IP level connection to execute IP level procedures and sends, in response to detecting the condition, an initiation signal to the radio access network via the radio access network interface.

The radio access network, in response to the initiation signal, initiates a radio bearer setup to establish a radio bearer between the radio access network and the mobile node to facilitate executing of the IP level procedures via the core network access interface. The IP core network is preferably an IP(version 4) or an IP(version 6) network that may include support for respective mobility protocols. According to a further embodiment, a mobile node of the present invention includes a processor coupled to memory and a user interface to facilitate user interaction with the mobile node device. The mobile node further includes transceiver circuitry coupled to the processor and adapted for communicating with an IP core network and a radio access network. The processor, when in an L-2 dormant state, detects a condition requiring enablement of IP level connection to execute IP level procedures. In response to detecting the condition, the processor sends an initiation signal to the radio access network to initiate a radio bearer setup to establish a radio bearer between the radio access network and the mobile node device to facilitate executing of the IP level procedures. The conditions detected and IP level procedure executed include those discussed above.

In accordance with another embodiment, a communication system, which provides for connectivity with a radio access network and an IP core network, includes a radio access network interface for accessing the radio access network. The system further includes a controller communicatively coupled to the radio access network interface. The controller receives an initiation signal from an L-2 dormant mobile node and, in response to the initiation signal, initiates a radio bearer setup to establish a radio bearer between the radio access network and the mobile node to facilitate executing of the IP level procedures via the IP core network. The radio bearer can be a default radio bearer associated with the mobile node.

According to this embodiment, if IP paging is supported by the system, the radio access network broadcasts an IP paging area identifier. The initiation signal received by the controller can include an RRC Connection Request. A list of Establishment Causes of the RRC Connection Request, in this case, includes an entry indicative of a need for a radio bearer setup. The initiation signal can include a Routing Area Update Request having an update type indicative of an IP paging area update request and a need for a radio bearer setup. Further, the initiation signal can include an L-2 QoS Request for setting up the radio bearer.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1A is a depiction of a Mobile IPv6 network environment within which methodologies of the present invention may be implemented;

FIG. 1B depicts signaling between a mobile node and each of an IP core network and a radio access network;

FIG. 2 illustrates a binding update procedure associated with updating an IP paging area location during node mobility in accordance with the present invention;

FIG. 3 illustrates various processes involving establishment of IP level connectivity by an L-2 dormant mobile node via an activation process to initiate IP level procedures according to an embodiment of the present invention;

FIG. 4 illustrates various processes involving establishment of IP level connectivity by an L-2 dormant mobile node via an activation process to initiate IP level procedures according to another embodiment of the present invention;

FIGS. 5 and 6 illustrate an exemplary signaling procedure between an L-2 dormant mobile node and an IP network that effects regaining of IP level connectivity therebetween, in the case of an IP paging area change, via mobile node activation of a network initiated radio bearer in accordance with the present invention;

FIG. 7A depicts a methodology directed to regaining IP layer-3 level connectivity between an L-2 dormant mobile node and an IP network that involves activation of the L-2 dormant mobile node in response to a paging request; FIG. 7B depicts a methodology directed to regaining IP layer-3 level connectivity between an L-2 dormant mobile node and an IP network to facilitate initiation of an IP call by the mobile node;

FIG. 8 depicts a methodology directed to regaining IP layer-3 level connectivity between an L-2 dormant mobile node and an IP network that involves expiring of an L-2 dormant timer associated with the mobile node; and

FIGS. 9 and 10 illustrate an IP paging model within which methodologies of the present invention may be implemented.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF VARIOUS EMBODIMENTS

In the following description of the illustrated embodiments, reference is made to the accompanying drawings which form a part hereof, and in which is shown by way of illustration, various embodiments in which the invention may be practiced. It is to be understood that the embodiments may be utilized and structural changes may be made without departing from the scope of the present invention.

The present invention is directed to a method, system, and device for establishing IP level connectivity by an L-2 dormant mobile node via an activation process in order to initiate IP level network procedures. In accordance with the present invention, a method and system provide for establishing a radio bearer between a radio access network and a mobile node while in a layer-2 (L-2) dormant state to enable IP level procedures at an IP core network. A method and system of the present invention enables an L-2 dormant mobile node to request a radio access network to create radio bearers as part of layer-2 update procedures.

By way of example, and as will be described in greater detail hereinbelow, the present invention provides for updating the IP paging area location during node mobility (e.g., cell reselection), refreshing the expiring IP dormant state of a mobile node, and activating an L-2 dormant mobile node to perform network procedures to regain IP (layer-3) level connectivity. The present invention finds particular applicability within IP and Mobile IP networks, such as IPv4, IPv6, Mobile IPv6, and Mobile IPv4 networks.

More particularly, methodologies of the present invention provide for a layer-2 mechanism to trigger the setup of a radio bearer when the mobile node needs to execute a layer-3 procedure. The radio bearer may, for example, be a default radio bearer associated with a given mobile node. When a mobile node is dormant, the mobile node monitors the broadcast or paging channel. The mobile node may, for example, receive a paging request from the network, or may receive a new IP paging area identity (IP-PA_Id) over the broadcast or paging channel. In addition, the mobile node may also need to exchange layer-3 messages, such as in the case of paging area location updating, with the network when an L-2 dormant timer associated with the mobile node is about to expire. Further, the L-2 dormant mobile node may also want to originate an IP call and, prior to doing so, needs to establish IP level connectivity.

The paging request, mobile node IP call origination, new IP-PA_Id or new Radio Routing Area (RRA), or expiring L-2 dormant timer condition triggers the mobile node to initiate an activation process by which layer-3 procedures can be performed, such as neighbor discovery, paging update, and/or binding update (BU) procedures. However, the layer-3 procedure first requires the setup of a radio bearer.

Mechanisms of the present invention allow the mobile node to trigger the setup of a radio bearer to the network. This is because, in the UMTS, the actual radio bearer establishment is always initiated by network. Mechanisms of the present invention that can be used to effect triggering of the network initiated radio bearer setup include use of a modified Routing Area Update Request, a modified RRC Connection Request, or a new layer-2 message with an indication that the setup is for the radio bearer, which may be a default radio bearer.

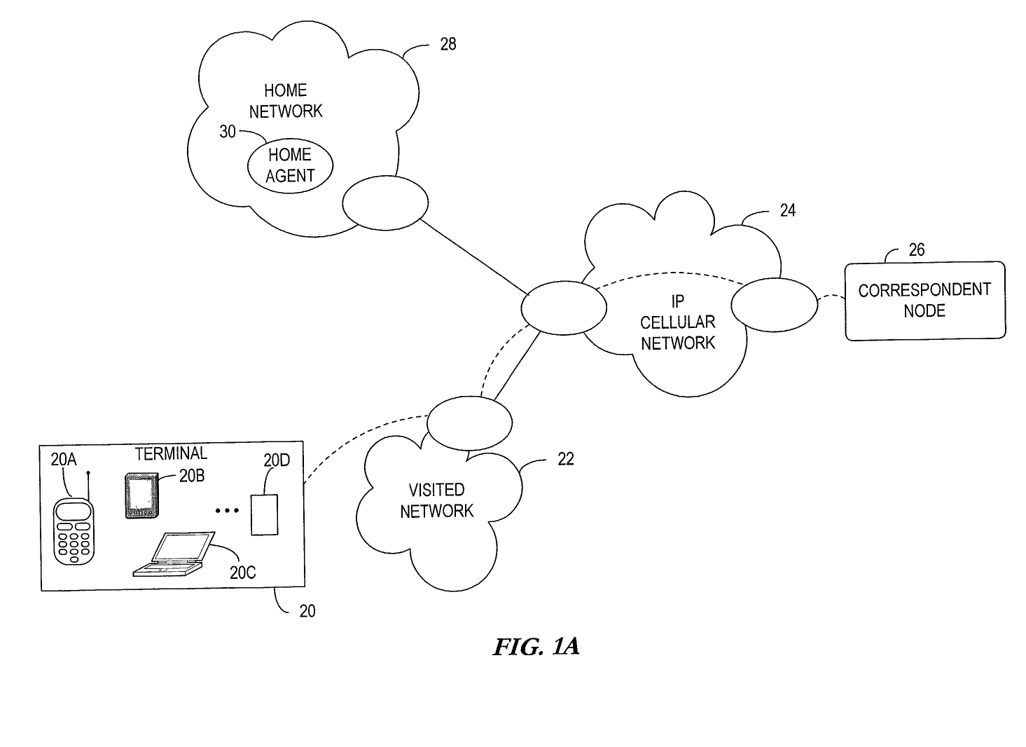

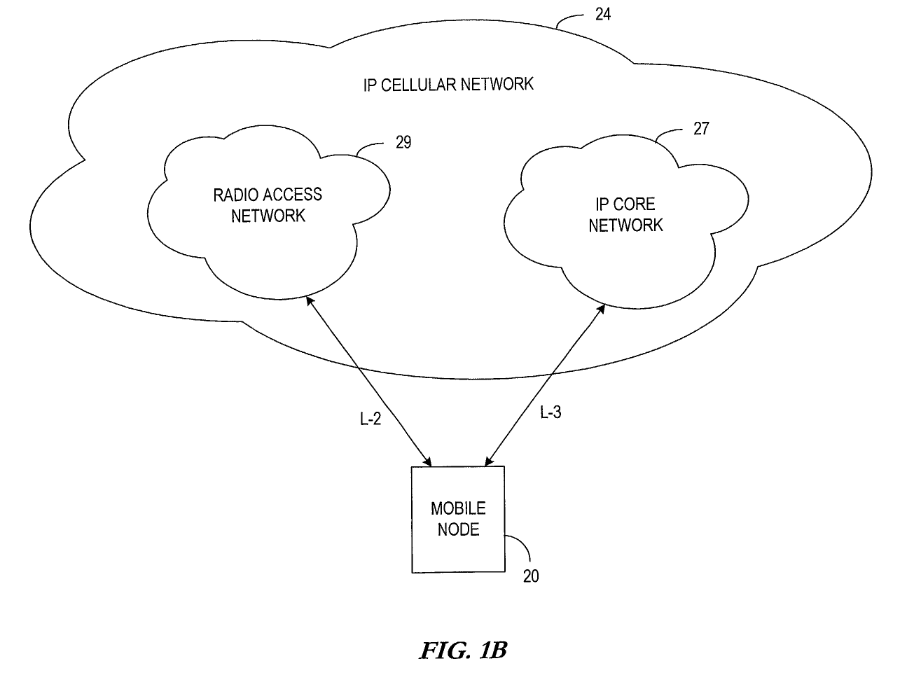

For purposes of illustrating various features and advantages of the present invention, aspects of the present invention will be generally described within the context of a Mobile IP network environment. Referring now to FIG. 1, there is illustrated a mobile network environment within which a method and system of the present invention may be implemented and employed. The present invention finds particular applicability in a mobile IP network environment, such as a Mobile IPv4, IPv6, or hybrid IPv4/IPv6 network environment. In general, the features and advantages of the present invention will be described herein within the context of a Mobile IPv6 network, such as a full-IP cellular network, it being understood that the present invention can be employed within a variety of mobile network environments.

The network depicted in FIG. 1 preferably conforms to a Mobile IPv6 network standard. The features and advantages of the present invention, as mentioned previously, are particularly applicable within the context of a Mobile IPv6 cellular network environment. Mobile IPv6 is a protocol currently being developed in the Mobile IP Working Group of the IETF (Internet Engineering Task Force), and it builds on the original Mobile IP protocol, referred to as Mobile IPv4. The intention of Mobile IPv6 is to provide a functionality for handling terminal, or node, mobility between IPv6 subnets. The protocol was designed to allow a node to change its point of attachment to the IP network in such a way that the change does not affect the addressability and reachability of the node.

Mobile IPv6 provides the mobility management functionality in the IP layer, specifically the IPv6 layer. As the IP layer is the only common protocol layer for all the applications used in IP networks, specifically in the Internet, handling mobility in the IP layer permits the mobility of a node to be transparent to the applications and protocol layers above the IP layer. Further, the mobility of a node between networks having different link layer mechanisms can be achieved without the need to specify interworking mechanisms between these networks for handling the inter-technology mobility. Thus, Mobile IPv6 provides an easily deployable mechanism for handling the mobility of users in a multi-access environment that can include any available or future access technologies.

The general problem with IP mobility is that when an IP mobile node moves to a new subnet, the IP mobile node either has to change its IP address to reflect the new point of attachment, or the routers must have host specific routes for the IP mobile node. Both of these alternatives have their drawbacks. Mobile IP in general, and more specially Mobile IPv6, solves the problem of mobility of a mobile node by managing the correlation of the changing IP address of the mobile node, called the care-of address (CoA), to an IP address permanently or semi-permanently assigned to the mobile node.

FIG. 1 depicts an illustrative Mobile IPv6 network environment in which a mobile node 20, connected to a visited or foreign network 22, communicates with a correspondent node (CN) 26 via an IP cellular network 24 and home network 28. The mobile node 20 can be embodied as a mobile terminal 20A, a PDA 20B, a portable PC 20C or any other type of mobile telecommunications terminal equipment 20D. For purposes of clarity, the mobile node 20 will be discussed as being embodied as a mobile terminal 20A, such as a cellular telephone.

According to a typical implementation, the mobile node 20 includes a processor coupled to memory and a user interface to facilitate user interaction with the mobile node 20. The mobile node 20 further includes transceiver circuitry coupled to the processor and adapted for communicating with an IP core network and a radio access network.

The mobile node 20 is assigned a permanent or semi-permanent IP address referred to as the home address of the mobile node 20. The applications and protocol layers above the IP layer in the mobile node 20 and correspondent nodes 26, which are the nodes with which the mobile node 20 is communicating, use the home address when they need to use the services of the IP layer. It is then the task of the Mobile IPv6 functionality in each node's IP layer to take into account the current care-of address, and thus the topological location, of the mobile node 20.

The home address of the mobile node 20 has a network prefix of a link (or subnet) of the mobile node's so called home link associated with the mobile node's home network 28. All packets sent to the mobile node's home address are routed to the home link, where a network element referred to as a home agent (HA) 30 is present. The home agent 30 maintains a mapping, referred to as the binding, between the (primary) care-of address and the home address of each mobile node 20 for which it functions as the home agent 30. When the binding for a mobile node 20 is active in the home agent 30, the home agent 30 will capture all packets sent to the mobile node's home address and forward them by tunneling to the care-of address. When route optimization is utilized, the correspondent nodes 26 no longer need to send the IP packets destined to the mobile node 20 through the home agent 30. Instead, the mobile node 20 will inform the correspondent nodes 26 about its current care-of address, so that the correspondent nodes 26 will be able to send the packets using the mobile node's current care-of address and thus, the packets are routed directly to the mobile node.

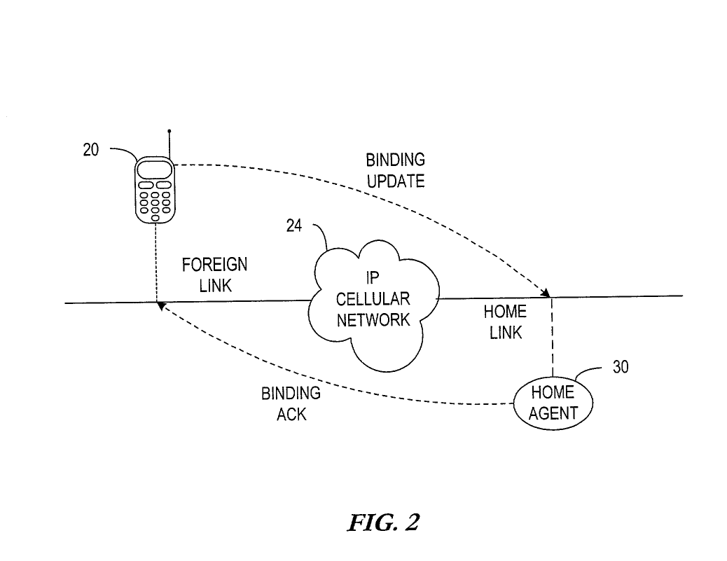

Three IPv6 destination options are employed in Mobile IPv6 for binding management. As is depicted in FIG. 2, a binding update is sent by the mobile node 20 to the home agent 30, or alternatively the correspondent node 26 shown in FIG. 1, for informing the home agent 30 or the correspondent node 26 about the mobile node's current care-of address. A binding acknowledgement (BAck) is sent by the home agent 30 or correspondent node 26 to the mobile node 20 as a response to the binding update. A binding request is sent by the home agent 30 or correspondent node 26 to the mobile node 20 for requesting the mobile node 20 to send a binding update. FIG. 2 illustrates the mobile node 20 sending a binding update to the home agent 30, which responds with a binding acknowledgement.

Whenever the mobile node 20 moves from one subnet or network to another, the mobile node 20 acquires a new care-of address, which needs to be registered with the home agent 30 serving the mobile node 20. This process involves the following events: 1. Movement detection: The mobile node 20 determines that it has moved and needs to acquire a new care-of address. In IPv6, this is facilitated in general by the router advertisements being sent periodically by the subnet routers. In cellular networks, the movement detection can be coordinated with link layer movement detection mechanisms. 2. Acquisition of a co-located care-of address by some mechanism (e.g., stateless autoconfiguration). 3. Registration of the new care-of address with the home agent 30.

The ability to effectively communicate with a mobile node 20 and to carryout out IP level procedures is complicated when the mobile node 20 is in an L-2 dormant state. In general terms, dormancy of a mobile node 20 is a function of the reachability of the mobile node 20 at the IP level. When in an IP active state, a mobile node 20 has previously performed a registration procedure to access the network 24, has a valid IP address, and is capable of sending and receiving packets without need for additional signaling.

When in an L-2 dormant state, the mobile node 20 is not reachable at the IP level (i.e., L-3 layer). The mobile node 20 is, however, reachable using signaling at the link layer (i.e., L-2 layer, such as a cellular access link layer). For example, an L-2 dormant mobile node 20 can monitor a broadcast or paging channel for a paging request. The L-2 dormant mobile node 20 can also monitor the broadcast or paging channel for a new IP paging area identifier (IP-PA_Id) resulting from the mobile node 20 moving from a cell belonging to a particular IP-PA to a new cell belonging to another IP-PA. In this regard, location tracking of the L-2 dormant mobile node 20 is accomplished at the IP-PA level, in that the routing information is available to route packets to the “paging area” or, more particularly as will be discussed, to the node acting as a paging function or agent. While L-2 dormant, the mobile node 20 wakes up only to perform certain operations, such as listening for paging and signaling when entering a new IP-PA, for example. In order to forward packets to the mobile node 20, the network 24 needs to page the mobile node 20 at the IP level (e.g., IP paging).

Receiving a paging request, originating an IP call, a new IP-PA_Id or RRA, or detection that the L-2 dormant timer is expiring will trigger the mobile node 20 to perform IP level (i.e., layer-3) procedures to activate the L-2 dormant mobile node 20, or to update the paging area location using binding update, or to refresh the IP dormant state of the mobile node 20. These layer-3 procedures require the mobile node 20 to initiate establishment of a radio bearer over which the L-3 messages are to be carried. Although it is the network 24 that initiates the radio bearer setup, the network 24, by way of example, has no idea if the mobile node 20 needs to update its paging area location.

From a cellular access point of view, for example, management of radio bearers, such as to setup, modify and release radio bearers, is a significant challenge. In current cellular systems, such as UTRAN for example, the initial request for a network connection with a given QoS originates from the mobile node 20 in the form of PDP context. This PDP context request is sent as NAS (Non Access Stratum) information directly to the core network (e.g., SGSN), without the cellular access point (CAP) interpreting it. The trigger for the setup of the radio bearer is coming from the core network, (e.g. SGSN in 3GPP networks) and is therefore external to the cellular access point. The challenge is to decide how to trigger the radio bearer set up when the layer-3 technology, IP, is completely unaware of the concept of a radio bearer.

By way of example, and with reference to FIG. 1B, a mobile node 20 is shown in communication with an IP cellular network 24. The IP cellular network 24 includes an IP core network 27 and a radio access network 29. In general, IP or layer-3 signaling facilitates communication between the IP core network 27 and the mobile node 20. Layer-1 and Layer-2 signaling facilitates communication between the radio access network 29 and the mobile node 20. In broad and general terms, a method and system in accordance with the principles of the present invention provides for initiating establishment of IP level connectivity by an L-2 dormant mobile node via an activation process in order to initiate IP level procedures.

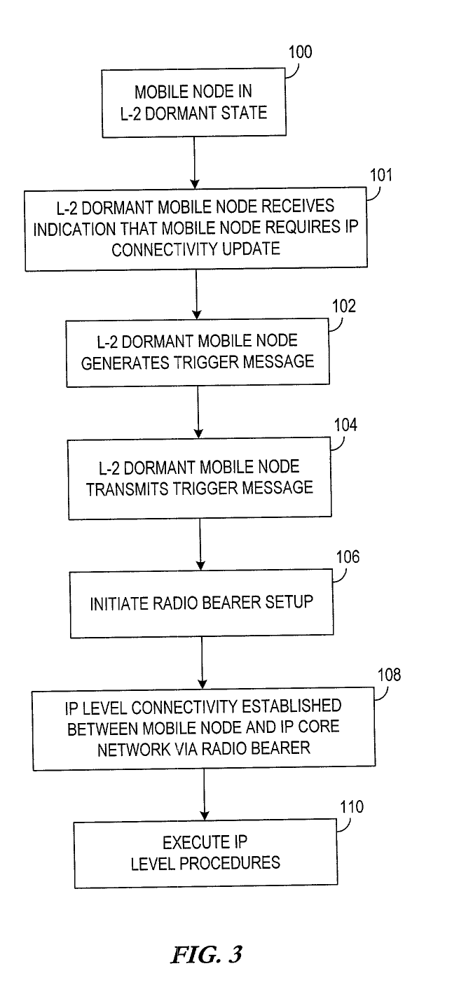

More particularly, and in accordance with an embodiment of the present invention, a layer-2 (link layer) mechanism is employed to trigger the setup of a radio bearer when the mobile node 20 needs to execute a layer-3 (IP layer) procedure. According to the present invention, the mobile node 20 sends a trigger to the network 24 so that the radio access network 29 initiates setup of the radio bearer, which may be a default radio bearer. This trigger is preferably a unique or modified layer-2 message. Turning now to FIG. 3, there is illustrated various processes involving establishment of IP level connectivity by employment of an L-2 dormant mobile node activation process according to an embodiment of the present invention. As shown, it is assumed that the mobile node is in an L-2 dormant state 100. The L-2 dormant mobile node receives 101 an indication or detects a condition that the L-2 dormant mobile node requires up to date IP level connectivity information. Such an indication or condition includes, for example, a change of IP paging area or, in the case that IP paging is not supported or available, a change of Radio Routing Area (RRA). Other indications or conditions include an indication that a dormant timer is expired, the L2 dormant mobile node is initiating an IP call, or the L2 dormant mobile node is receiving a paging request.

In response to the received indication or detected condition 101, the L-2 dormant mobile node generates 102 a trigger message or signal. The L-2 dormant mobile node transmits 104 the trigger message to a radio access network. In response to the trigger message, the radio access network initiates 106 setup of a radio bearer. IP level connectivity is established 108 between the L-2 dormant mobile node and IP network via the radio bearer. The mobile node then executes 110 IP level procedures.

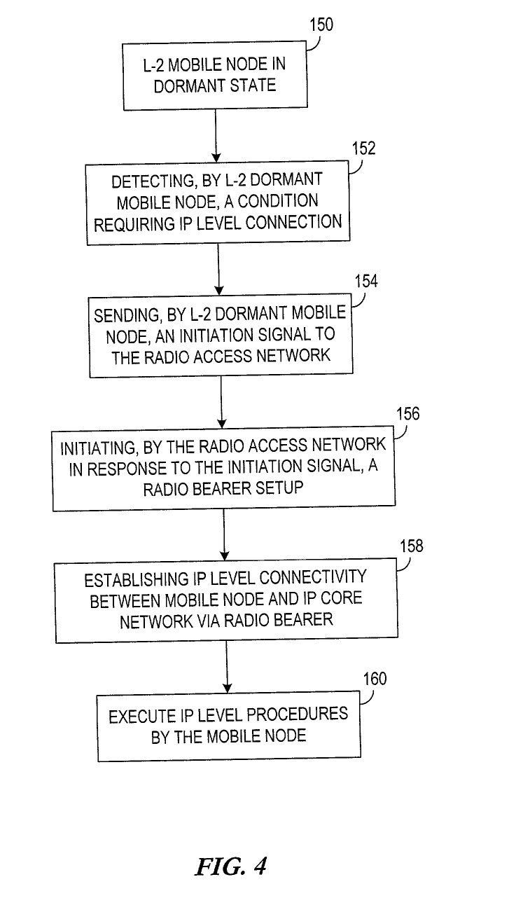

FIG. 4 illustrates various processes involving establishment of IP level connectivity by employment of an L-2 dormant mobile node activation process according to another embodiment of the present invention. In the embodiment depicted in FIG. 4, it is assumed that the mobile node is in an L-2 dormant state 150. The L-2 dormant mobile node detects 152 a condition that requires IP level connectivity with an IP core network. In response to detecting the condition, the L-2 dormant mobile node sends 154 an initiation signal to the radio access network. In response to the initiation signal, the radio access network initiates 156 a radio bearer setup. IP level connectivity is established 158 between the now active L-3 mobile node and IP core network. The mobile node then executes 160 IP level procedures.

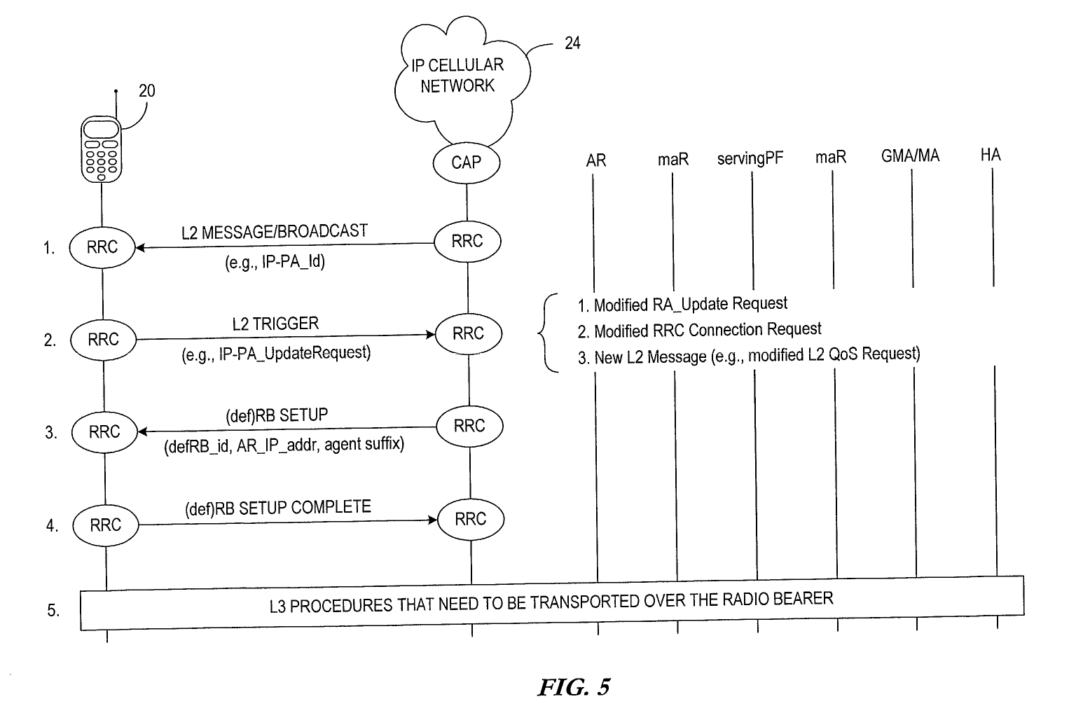

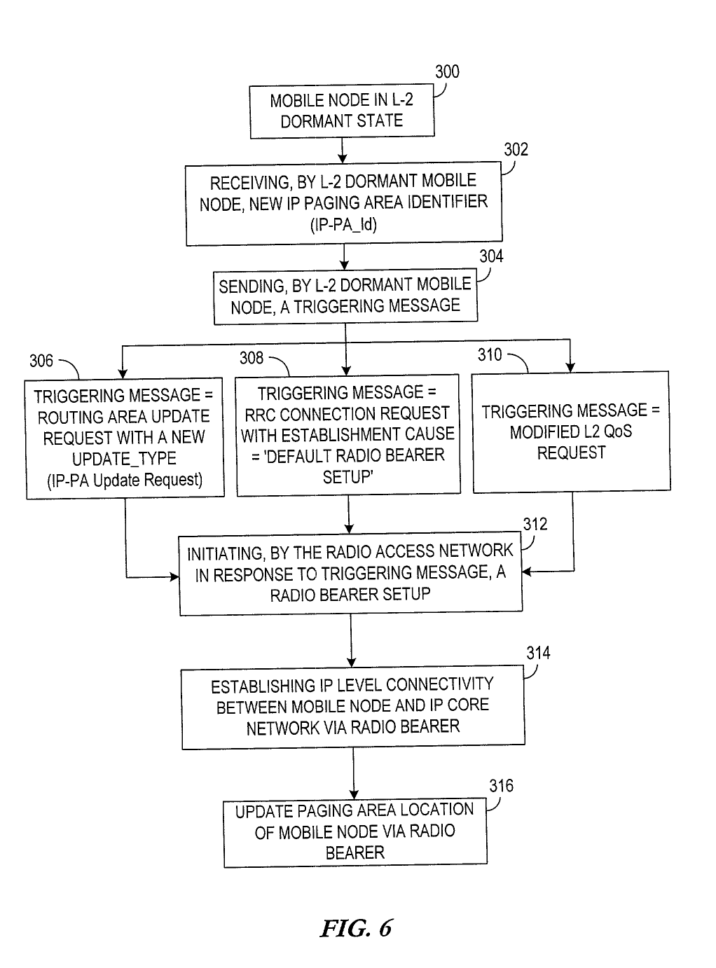

A further embodiment of the present invention is depicted in FIGS. 5 and 6. The methodology according to this embodiment is directed to updating the IP paging area location during mobility of an L-2 dormant mobile node 20 to regain IP layer-3 level connectivity with the IP core network 27 (shown in FIG. 1B) of the cellular network 24 for performing IP layer-3 level procedures. FIGS. 5 and 6 illustrate a signaling procedure between an L-2 dormant mobile node 20 and an IP cellular network 24 that effects regaining of IP level connectivity therebetween via mobile node activation of a radio access network initiated radio bearer in accordance with the present invention. In this illustrative example, signaling between the L-2 dormant mobile node 20 and a cellular access point (CAP) to an IP cellular network 24 is facilitated through use of Radio Resource Control (RRC) protocol.

Initially, it is assumed that the mobile node 20 is in an L-2 dormant state 300 (see FIG. 6). The L-2 dormant mobile node 20 is typically monitoring a broadcast or paging channel while in the L-2 dormant state. The L-2 dormant mobile node 20 receives 302 a layer-2 message or broadcast transmitted from the IP network 24, which in this illustrative example is a new IP paging area identifier (IP-PA_Id). The L-2 dormant mobile node 20, in this case, has moved from a cell belonging to a particular IP-PA to a new cell belonging to another IPPA, the IP-PA_Id being associated with the new cell.

In response to receiving a new IP paging area identifier (IP-PA_Id), the L-2 dormant mobile node 20 sends 304 a layer-2 trigger message to the radio access network 29 (shown in FIG. 1B) of the IP cellular network 24. The trigger message represents a link layer message which, when dispatched from the L-2 dormant mobile node 20 and received by the radio access network 29, causes the radio access network 29 to initiate a radio bearer setup. As is shown in FIGS. 5 and 6, three different triggering mechanisms are described, it being understood that other mechanisms for triggering network initiation of a radio bearer setup come within the scope of the present invention.

A first triggering mechanism involves use of a modified Routing Area Update Request 306, such as a modified IP-PA_UpdateRequest message. According this mechanism, the current Routing Area Update Request is modified to include a new ‘Update_Type.’ The new ‘Update_Type’ preferably occupies 3 bits and only 4 values are currently being used. One of the reserved values can be used to indicate that the ‘Update_Type’ is an IP-PA update request and that this IP-PA update request will trigger the network 24 to set up a radio bearer, which may be a default radio bearer. A second triggering mechanism involves use of a modified RRC Connection Request 308. In accordance with this mechanism, the current RRC Connection Request message is modified to include a new ‘Establishment Cause.’ The RRC Connection Request includes a list of enumerated ‘Establishment Cause’ identifiers. A new ‘Establishment Cause’ defined as ‘Default Radio Bearer Setup’ can be added in the RRC Connection Request list and this new ‘Establishment Cause’ will trigger the network 24 to set up a radio bearer.

In the case of an IP based cellular network in which IP paging is not available and the mobile node moves from one cell to another cell, for example, it is assumed that a new radio routing area (RRA) is served by a new access router (AR). If IP paging is not available, the new access router, which has a different prefix than the old (prior) access router, requires the mobile node to establish a new care-of address. Establishing a new care-of address can be accomplished by establishing a dedicated radio bearer, such as a default radio bearer. An RRC Connection Request message that includes a new ‘Establishment_Cause’ defined as ‘Default Radio Bearer Setup’ can thus be employed as a trigger message in the case where IP paging does not exist or is otherwise unavailable.

In the case of an IP based cellular network in which IP paging is available and the mobile node changes IP paging areas, as indicated by a new IP-PA_Id detected in the broadcast channel, the mobile node needs to perform IP procedures to update the mobile node's paging area location. These IP procedures require establishment of a dedicated (default) radio bearer, which can be accomplished using a triggering mechanism of the present invention.

A third triggering mechanism involves use of a new layer-2 message 310 with an indication that the setup is for the radio bearer. For example, the new layer-2 message can utilize a new or modified L-2 QoS Request to set up a radio bearer, such as a default radio bearer.

In response to the trigger message received from the L-2 dormant mobile node 20, the radio access network 29 initiates 312 a radio bearer setup. A radio bearer setup message (e.g., defRB_id, AR_IP_addr, agent suffix) is communicated from the radio access network 29 of the IP cellular network 24 to the L-2 dormant mobile node 20. The mobile node 20, in response, transmits a radio bearer setup complete message to the radio access network 29 of the IP cellular network 24. IP level connectivity is established 314 between the L-2 dormant mobile node 20 and IP core network 27 (shown in FIG. 1B) of the IP cellular network 24. The paging area location for the mobile node 20 is then updated 316 via the radio bearer.

A variety of IP level (e.g., layer-3) procedures may then be initiated by transport of layer-3 messages between the mobile node 20 and the IP core network 27. Such layer-3 procedures may involve various network entities and agents, including, for example, an access router (AR), serving paging function (PF) or home agent (HA).

As was previously discussed, a radio bearer setup according to the present invention can involve a default radio bearer. A default radio bearer should be predefined for each mobile node 20 that has layer-2 attachment to the IP cellular network 24. This radio bearer would be used as the mobile node's (default) radio bearer to exchange IP packets between the mobile node 20 and access router (AR) when no other radio bearer is available. The (default) radio bearer should be defined in a manner that reserves physical radio resources only when there is an IP packet to send and that minimizes signaling needed for re-configuration of radio channels (common, shared or dedicated channels).

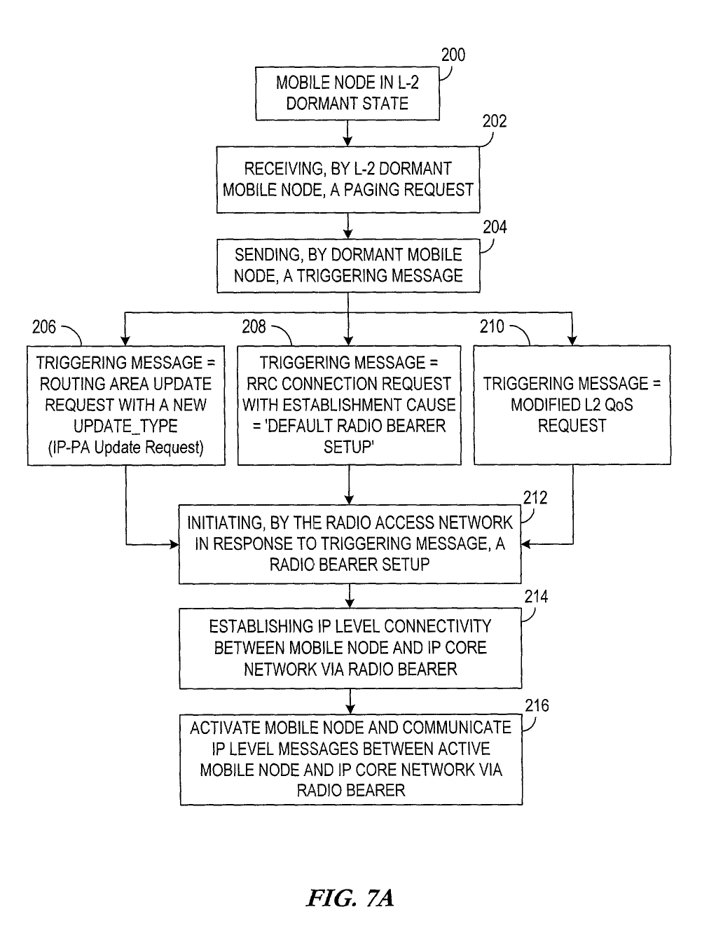

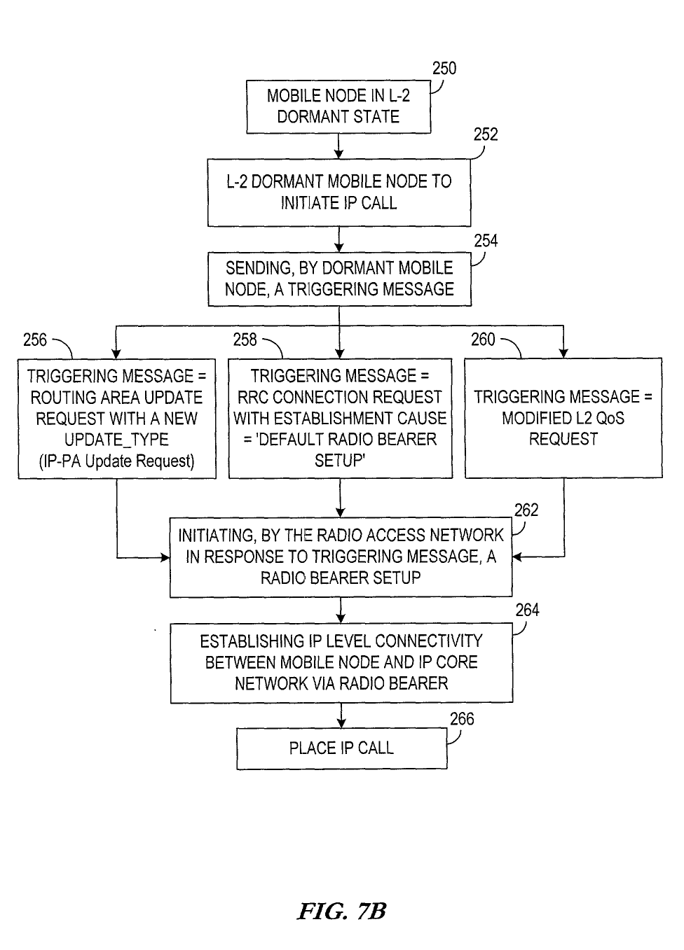

In accordance with another embodiment of the present invention, and with reference to FIG. 7A, there is depicted a methodology directed to regaining IP layer-3 level connectivity between an L-2 dormant mobile node 20 and an IP cellular network 24 that involves activation of the L-2 dormant mobile node 20 in response to a paging request. According to this methodology, it is initially assumed that the mobile node 20 is L-2 dormant 200. The L-2 dormant mobile node 20 monitors the broadcast or paging channel and receives a paging request 202. In response to the paging request, the L-2 dormant mobile node 20 sends a trigger message 204 to a radio access network 29 (shown in FIG. 1B) of the IP cellular network 24. The trigger message, as previously described, can be a modified Routing Area Update Request 206, a modified RRC Connection Request 208 or a new layer-2 message 210 with an indication that the setup is for the radio bearer.

In response to the trigger message received from the L-2 dormant mobile node 20, the radio access network 29 initiates 212 a radio bearer setup. IP level connectivity is established 214 between the mobile node 20 and IP core network 27 (shown in FIG. 1B) via the radio bearer. The mobile node 20 is activated 216 and available to perform IP level message communication and procedures.

FIG. 7B depicts a methodology directed to regaining IP layer-3 level connectivity between an L-2 dormant mobile node and an IP network to facilitate initiation of an IP call by the L-2 dormant mobile node according to a further embodiment of the present invention. As is shown in FIG. 7B, it is initially assumed that the mobile node 20 is L-2 dormant 250. The L-2 dormant mobile node 20 receives an indication or detects a condition 252 indicating that IP layer-3 level connectivity is required in order to facilitate placement of an IP call by the L-2 dormant mobile node 20. In response such indication or detected condition, the L-2 dormant mobile node 20 sends a trigger message 254 to a radio access network 29 (shown in FIG. 1B) of the IP cellular network 24. The trigger message, as previously described, can be a modified Routing Area Update Request 256, a modified RRC Connection Request 258 or a new layer-2 message 260 with an indication that the setup is for the radio bearer.

In response to the trigger message received from the L-2 dormant mobile node 20, the radio access network 29 initiates 262 a radio bearer setup. IP level connectivity is established 264 between the mobile node 20 and IP core network 27 (shown in FIG. 1B) via the radio bearer. An IP call can be initiated or placed 266 by the mobile node 20.

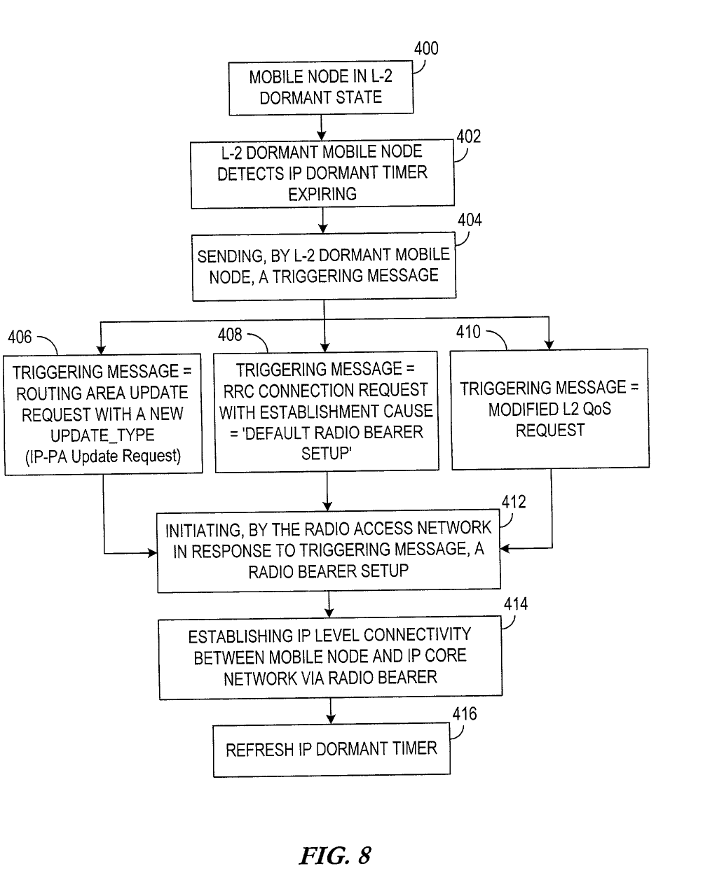

According to a further embodiment of the present invention, and with reference to FIG. 8, there is depicted a methodology directed to regaining IP layer-3 level connectivity between an L-2 dormant mobile node 20 and an IP cellular network 24 that involves expiring of an L-2 dormant timer associated with the mobile node 20. In accordance with this methodology, it is initially assumed that the mobile node 20 is L-2 dormant 400. The L-2 dormant mobile node 20 detects 402 that the L-2 dormant time is expiring. In response, the L-2 dormant mobile node 20 sends a trigger message 404 to radio access network 29 (shown in FIG. 1B). The trigger message, as previously described, can be a modified Routing Area Update Request 406, a modified RRC Connection Request 408 or a new layer-2 message 410 with an indication that the setup is for the radio bearer.

In response to the trigger message received from the L-2 dormant mobile node 20, the radio access network 29 initiates 412 a radio bearer setup. IP level connectivity is established 414 between the mobile node 20 and IP core network 27 (shown in FIG. 1B). The L-2 dormant timer is refreshed 416 via layer-3 messaging.

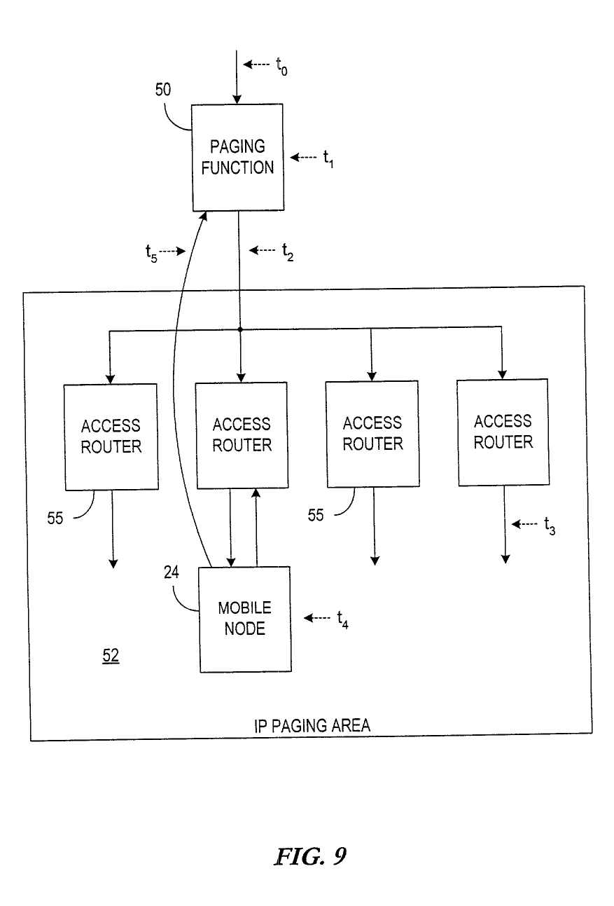

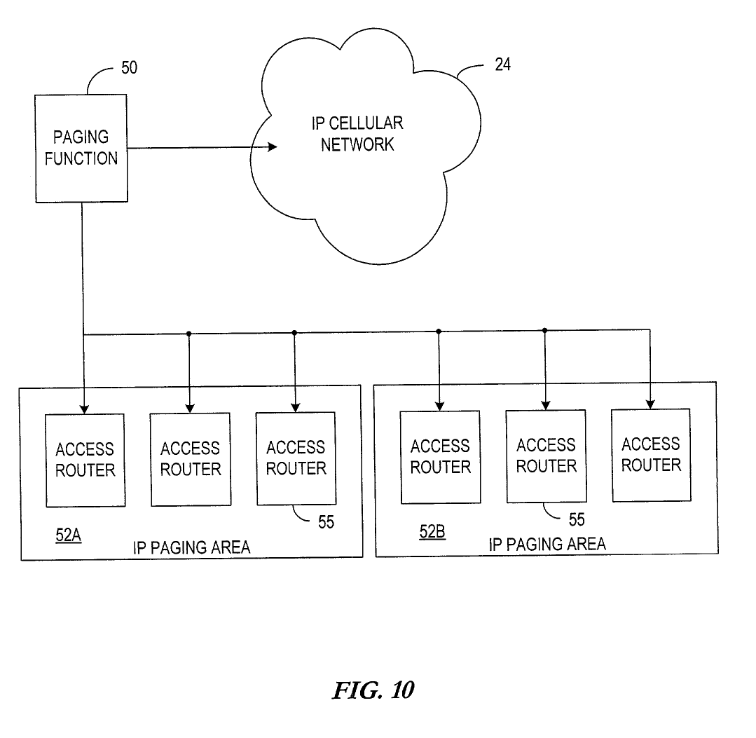

FIGS. 9 and 10 illustrate an IP paging model within which methodologies of the present invention may be implemented. According to the depicted model, a Paging Function (PF) 50 is defined as a single logical entity that performs the functions of a Dormant Mobility Agent, a Tracking Agent, and a Paging Agent.

The Paging Function 50 provides a single, trusted channel of paging-related communication between a mobile node 20 and the IP cellular network 24. For all paging purposes, the mobile node 20 communicates with the Paging Function 50 and secures its communication using an appropriate security association it shares with the Paging Function 50. Depending on where the Paging Function 50 is realized, the mobile node 20 only needs to deal with its Access Router 55 or visited domain Mobility Agent. Since the mobile node 20 deals with a single logical entity, the number of separate messages necessary to communicate with different elements, potentially over an expensive air interface, can be reduced.

Because the IP dormancy state of a mobile node 20 has to be checked before an IP packet can be delivered to the mobile node 20, all incoming packets traverse the Paging Function 50. The Paging Function 50 can determine that the mobile node 20 is dormant based on an explicit Paging Registration message that the mobile node 20 sends before entering the IP-dormant state. The Paging Function 50 may also determine, implicitly, that the mobile node 20 is IP-dormant based on a mobile node-specific timer (i.e., L-2 dormant timer) that expires in the event of traffic inactivity. When a mobile node 20 wakes up in response to paging, the Paging Function 50 performs Paging De-registration in order to update or remove the dormancy status of the mobile node.

When an IP packet arrives at a Paging Function 50, where the mobile node 20 has last established its presence, the Paging Function 50 has to determine how to forward the packet to the mobile node 20. The Paging Function 50 ascertains whether the mobile node 20 to which the packet is addressed has undergone dormant mode handover. One approach involves the mobile node 20 performing an explicit registration with the Paging Function 50 prior to undergoing the dormant mode handover. A second approach involves an implicit registration, in which the network 24 may initiate IP paging when it discovers that a mobile node 20 is no longer IP reachable. Once the Paging Function 50 determines the need for IP paging, the Paging Function 50 initiates a paging message addressed to an IP paging area (IP-PA). Each IP-PA is identified by an IP multicast group, whose members are typically all the access routers 55 to which a mobile node 20 could be “dormantly connected.”

As is shown in FIG. 9, and with reference also to FIG. 10, at time t₀, packets destined for the mobile node 20 arrive at the Paging Function 50. At time t₁, the Paging Function 50 ascertains that the mobile node 20 is L-2 dormant. At time t₂, the Paging Function 50 sends an “IP paging request” message to all access routers 55 within the IP paging area 52 where the mobile node 20 is located. At time t₃, the access router 55 converts an IP paging request message (e.g., a router advertisement with paging extension) into an appropriate L-2 paging message, and forwards the L-2 paging message to the mobile node 20. When L-2 paging is used, the L-3 paging Id is mapped to an L-2 paging Id.

At the assigned time slot (t₄), the L-2 dormant mobile node 20 wakes up and listens for the page on the paging channel. When detected, the mobile node 20 responds to the paging message with a paging response message to its access router 55. The mobile node 20 may dispatch a trigger message as part of the paging response or as a separate response to activate network initiation of the mobile node's radio bearer in a manner previously described. The mobile node 20, either subsequently or together with dispatching of the paging response message, performs an IP mobility procedure, such as neighbor discovery and binding update procedures. At time t₅, the mobile node 20 or its new access router 55 requests the Paging Function 50 to forward the buffered packets and delete the state of dormancy status of the mobile node 20.

FIG. 10 illustrates a typical Mobile IPv6 networking environment in which the methodologies of the present invention described herein can be implemented.

In particular, FIG. 10 illustrates a scenario where Mobile IPv6 is adopted in the IP cellular network 24. In such a case, the Paging Function 50 can be realized either in the access router 55 or it can be a node in the IP cellular network 24 not related to mobility (e.g., in the case of implicit dormancy). More than one Paging Function 50 for a given IP paging area can be used. For a given mobile node 20 connected to a given access router 55 in a given IP paging area (52A or 52B) that goes dormant in the given IP paging area, only one entity acts as the Paging Function 50 for the mobile node 20. Other dormant mobile nodes 24 in the IP paging area may be served by different Paging Functions 50.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method of establishing a radio bearer between a radio access network and a mobile node while in a layer-2 (L-2) dormant state to enable IP level procedures at an IP core network, comprising:
detecting, by the L-2 dormant mobile node, a condition requiring enablement of IP level connection to execute the IP level procedures;
sending, by the L-2 dormant mobile node in response to detecting the condition, an initiation signal to the radio access network; and
initiating, by the radio access network in response to the initiation signal, a radio bearer setup to facilitate executing of the IP level procedures.

2. The method of claim 1, wherein the radio bearer comprises a default radio bearer associated with the mobile node.

3. The method of claim 1, wherein detecting the condition comprises detecting an L-2 message.

4. The method of claim 1, wherein detecting the condition comprises detecting a paging request.

5. The method of claim 1, wherein detecting the condition comprises detecting information indicative of an IP paging area change.

6. The method of claim 1, wherein detecting the condition comprises detecting an L-2 broadcast or paging message.

7. The method of claim 1, wherein, in an absence of IP paging, detecting the condition comprises detecting a radio routing area change, and initiating the radio bearer setup facilitates execution of the IP level procedures.

8. The method of claim 1, wherein:
detecting the condition comprises detecting a new routing area identifier; and
executing of the IP level procedures comprises obtaining new IP connectivity information of the mobile node and updating the new IP connectivity information to the IP core network.

9. The method of claim 1, wherein detecting the condition comprises detecting in the L-2 dormant mobile node an indication to originate an IP call requiring IP level connectivity with the IP core network.

10. The method of claim 9, wherein executing of the IP level procedures comprises obtaining new IP connectivity information of the mobile node and updating the new IP connectivity information to the IP core network.

11. The method of claim 1, wherein detecting the condition comprises detecting expiration of a timer in the dormant mobile node.

12. The method of claim 11, wherein the timer comprises an L-2 dormant timer in the dormant mobile node.

13. The method of claim 11, wherein executing of the IP level procedures comprises refreshing a dormant state of an IP dormant timer of the mobile node.

14. The method of claim 1, further comprising establishing, in response to initiating the radio bearer setup, IP level connectivity between the mobile node and the IP core network.

15. The method of claim 1, wherein executing of the IP level procedures comprises communicating IP level messages between the mobile node and the IP core network.

16. The method of claim 1, wherein executing of the IP level procedures comprises obtaining a new IP address for the mobile node.

17. The method of claim 1, wherein executing of the IP level procedures comprises activating the mobile node.

18. The method of claim 1, wherein executing of the IP level procedures comprises sending a paging update message to the IP core network.

19. The method of claim 1, wherein:
detecting the condition comprises detecting a new IP paging area identifier; and
executing of the IP level procedures comprises updating a paging area location of the mobile node.

20. The method of claim 19, wherein a binding update is performed to update the paging area location of the mobile node.

21. The method of claim 1, wherein the initiation signal comprises a Routing Area Update Request having an update type indicative of an IP paging area update request and a need for a radio bearer setup.

22. The method of claim 1, wherein the initiation signal comprises an RRC Connection Request, a list of Establishment Causes of the RRC Connection Request including an entry indicative of a need for a radio bearer setup.

23. The method of claim 1, wherein the initiation signal comprises an L-2 QoS Request for setting up the radio bearer.

24. The method of claim 1, wherein the IP core network comprises an IP(version 4) or an IP(version 6) network that includes support for respective mobility protocols.

25. A communication system, comprising a core network access interface for accessing an IP core network;
a radio access network interface for accessing a radio access network; and
a mobile node, the mobile node, when in an L-2 dormant state, detecting a condition requiring enablement of IP level connection to execute IP level procedures and sending, in response to detecting the condition, an initiation signal to the radio access network via the radio access network interface, the radio access network, in response to the initiation signal, initiating a radio bearer setup to establish a radio bearer between the radio access network and the mobile node to facilitate executing of the IP level procedures via the core network access interface.

26. The system of claim 25, wherein the radio bearer comprises a default radio bearer associated with the mobile node.

27. The system of claim 25, wherein the condition detected by the mobile node comprises detecting an L-2 message.

28. The system of claim 25, wherein the condition detected by the mobile node comprises a paging request.

29. The system of claim 25, wherein the condition detected by the mobile node comprises information indicative of an IP paging area change.

30. The system of claim 25, wherein the condition detected by the mobile node comprises detecting an L-2 broadcast or paging message.

31. The system of claim 25, wherein, in an absence of IP paging, the condition detected by the mobile node comprises a radio routing area change, the radio bearer setup facilitating execution of the IP level procedures.

32. The system of claim 25, wherein:
the condition detected by the mobile node comprises a new routing area identifier; and
executing of the IP level procedures comprises obtaining new IP connectivity information of the mobile node and updating the new IP connectivity information to the IP core network.

33. The system of claim 25, wherein the condition detected by the mobile node comprises an indication to originate an IP call requiring IP level connectivity with the IP core network.

34. The system of claim 25, wherein IP level messages are communicated between the mobile node and the IP core network via the core network access interface.

35. The system of claim 25, wherein:
the condition detected by the mobile node comprises a new IP paging area identifier; and
executing of the IP level procedures comprises updating a paging area location of the mobile node.

36. A mobile node device, comprising a processor coupled to memory;
a user interface to facilitate user interaction with the mobile node device; and
transceiver circuitry coupled to the processor and adapted for communicating with an IP core network and a radio access network, the processor, when in an L-2 dormant state, detecting a condition requiring enablement of IP level connection to execute IP level procedures and sending, in response to detecting the condition, an initiation signal to the radio access network to initiate a radio bearer setup to establish a radio bearer between the radio access network and the mobile node device to facilitate executing of the IP level procedures.

37. The device of claim 36, wherein the condition detected by the processor comprises detecting an L-2 message.

38. The device of claim 36, wherein the condition detected by the processor comprises a paging request.

39. The device of claim 36, wherein the condition detected by the processor comprises information indicative of an IP paging area change.

40. The device of claim 36, wherein the condition detected by the processor comprises detecting an L-2 broadcast or paging message.

41. The device of claim 36, wherein, in an absence of IP paging, the condition detected by the processor comprises a radio routing area change.

42. The device of claim 36, wherein the condition detected by the processor comprises expiration of a timer in the mobile node device.

43. The device of claim 36, wherein the condition detected by the processor comprises an indication to originate an IP call requiring IP level connectivity with the IP core network.

44. The device of claim 36, wherein IP level messages are communicated between the transceiver and the IP core network.

45. The device of claim 36, wherein executing of the IP level procedures comprises obtaining a new IP address for the mobile node device.

46. The device of claim 36, wherein executing of the IP level procedures comprises sending a paging update message to the IP core network.

47. A communication system which provides for connectivity with a radio access network and an IP core network, comprising:
a radio access network interface for accessing the radio access network; and
a controller communicatively coupled to the radio access network interface and receiving an initiation signal from an L-2 dormant mobile node, the controller, in response to the initiation signal, initiating a radio bearer setup to establish a radio bearer between the radio access network and the mobile node to facilitate executing of the IP level procedures via the IP core network.

48. The system of claim 47, wherein the radio bearer comprises a default radio bearer associated with the mobile node.

49. The system of claim 47, wherein the system supports IP paging, and the radio access network broadcasts an IP paging area identifier.

50. The system of claim 47, wherein the initiation signal comprises an RRC Connection Request, a list of Establishment Causes of the RRC Connection Request including an entry indicative of a need for a radio bearer setup.

51. The system of claim 47, wherein the initiation signal comprises a Routing Area Update Request having an update type indicative of an IP paging area update request and a need for a radio bearer setup.

52. The system of claim 47, wherein the initiation signal comprises an L-2 QoS Request for setting up the radio bearer.
